(19) United States
(12) Patent Application Publication
(10) Pub. No.: US 2006/0255485 A1
(43) Pub. Date: Nov. 16, 2006

(54) Method for fabricating optical preform

(76) Inventor: Chien-Shun Chen, Douliou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,834

(22) Filed: Aug. 19, 2005

(30) Foreign Application Priority Data
May 11, 2005 (TW) 94115263

(51) Int. Cl. B29D 11/00; G02B 6/00

(52) U.S. Cl. 264/1.24

(57) ABSTRACT

A method for fabricating a graded index optical preform includes the following steps. A first composition containing an oligomer is added into a cylindrical reactor with a diameter. The first composition is polymerized in a centrifugal field to form a hollow cylindrical substrate having an outer diameter being the same as the diameter of the cylindrical reactor and an inner diameter. A ratio of components in a second composition is determined according to a refraction index profile of the hollow cylindrical substrate between the outer diameter and the inner diameter. The second composition is added into the hollow column of the hollow cylindrical substrate to allow swelling the hollow cylindrical substrate. The second composition is polymerized to obtain the optical preform.

### RELATED APPLICATIONS

The present application is based on, and claims priority from, Taiwan Application Serial Number 94115263, filed on May 11, 2005, the disclosure of which is hereby incorporated by reference herein in its entirety.

### BACKGROUND

1. Field of Invention

The present invention relates to a method for fabricating an optical material. More particularly, the present invention relates to a method for fabricating an optical preform.

2. Description of Related Art

Due to its extremely low power loss, optical fiber has gradually replaced traditional cable as a data transmission medium. Generally speaking, optical fiber is fabricated from either of two materials: silicon oxide or plastic.

Compared with silicon oxide, plastic materials are especially useful in fabricating large-diameter optical fibers because of their lower cost, lower weight and higher flexibility. In the field of the optical fiber application, one way to make optical fibers needs to fabricate an optical rod, which is called an optical preform, in advance. There are many methods currently available for fabricating an optical preform, especially for a graded index optical preform, such as the centrifugal method and the swelling method.

The centrifugal method adds an oligomer into a reaction tank that generates a centrifugal field, in which the oligomer undergoes polymerization at a specific temperature. The centrifugal method is problematic when the optical preform is reprocessed to form optical fibers because it leaves the optical fiber product with a hollow column due to shrinkage of the polymer caused by the centrifugal force. In order to eliminate the problem, a step of inputting monomer must be repeated until no substantial hollow column remains.

The swelling method involves first adding monomers of different refraction index and an initiator into a substrate tank, and then leaving them to swell at a temperature lower than the reaction temperature of the initiator initiating the polymerization. The temperature is raised to complete the polymerization after sufficient swelling is achieved. Compared with the centrifugal method, although the swelling method does not generate a hollow column within the product, it does generate considerable voids throughout the product due to the total volume shrinkage caused by polymerization of the monomers. This eventually limits the size of the final optical preform because of the larger volume the more voids. In addition, the uniformity of the refraction index profile along the length of the fiber is not as good as that produced by the centrifugal method.

For the foregoing reasons, there is a need for a novel method with the merits of both the centrifugal method and the swelling method but without the shortcomings of both.

### SUMMARY

It is therefore an aspect of the present invention to provide a method for fabricating a graded index optical preform. The method does not require repeatedly adding reactants into a reaction tank when a centrifugal field is generated to make a graded index optical preform without an unwanted hollow column. The method saves considerable processing time and also eliminates voids from the product.

It is another aspect of the present invention to provide a method for fabricating a graded index optical preform. The novel method simultaneously has the merits of both the centrifugal method and the swelling method.

In accordance with the foregoing and other objectives of the present invention, a method for fabricating an optical preform is disclosed. The method includes the following steps. A first composition containing multiple components, in which at least one component is an oligomer, is added into a cylindrical reactor with a diameter. Second, the first composition is polymerized in a centrifugal field to form a hollow cylindrical substrate with an outer diameter being the same as the diameter of the cylindrical reactor and an inner diameter. Then, a ratio of components, which are not necessarily the same as those of the first composition, is determined in a second composition according to a refraction index profile between the outer diameter and the inner diameter of the hollow cylindrical substrate. Next, the second composition is added into the hollow column of the hollow cylindrical substrate to allow swelling without any centrifugal field. Finally, the second composition is polymerized to obtain the desired graded index optical preform without any hollow column and voids.

According to one preferred embodiment of the present invention, the components, such as methyl methacrylate, 2,2,2-trifluoroethyl methacrylate, 2,2,3,3-tetrafluoropropyl methacrylate, benzyl methacrylate, vinyl acetate, diphenyl sulfide or styrene, in the first composition and the second composition may be different from one another and may have ethylenically unsaturated double bond. The first composition and the second composition may additionally include a polymerization initiator.

When using the method of the present invention for fabricating the graded index optical preform, repeatedly adding reactants into the reaction tank and generating a centrifugal field are not required for saving time. The graded index optical preform fabricated by the present invention neither contains a hollow column, which causes dispersion during optical signal transmission, nor exhibits any significant voids caused by total volume shrinkage as compared to the traditional swelling method because the inner diameter generated by centrifugal filed is not large enough to cause voids. Furthermore, the refraction index profile of the graded index optical preform fabricated by the method of the present invention can be nearly ideal by calculating proper ratio of components in the first and the second compositions.

It should be understood that both the foregoing general description and the following detailed description are by examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1 illustrates the centrifugal steps of the present invention and shows the relative refraction index of the obtained hollow cylindrical substrate;

FIG. 2 illustrates the swelling steps and shows the relative refraction index of the optical preform;

FIG. 3 shows the relative refraction index plotted vs. normalized radial distance of a hollow cylindrical substrate fabricated from the pre-polymerized benzyl methacrylate of the first composition;

FIG. 4 shows the relative refraction index plotted vs. normalized radial distance of a hollow cylindrical substrate fabricated from non pre-polymerized benzyl methacrylate of the first composition;

FIG. 5 shows the refraction index profile plotted vs. normalized radial distance of a hollow cylindrical substrate taken from the 3500 rpm in FIG. 3 after the swelling steps; and

FIG. 6 illustrates the light path in the graded index optical preform.

### DESCRIPTION OF THE PREFERRED EMBODIMENTS

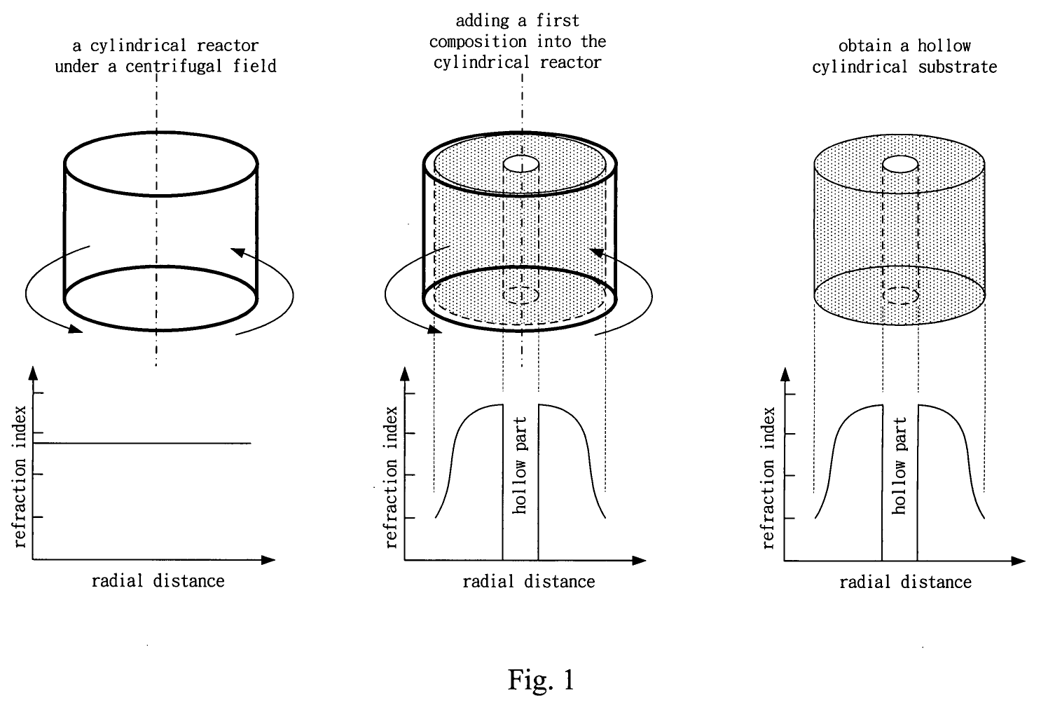

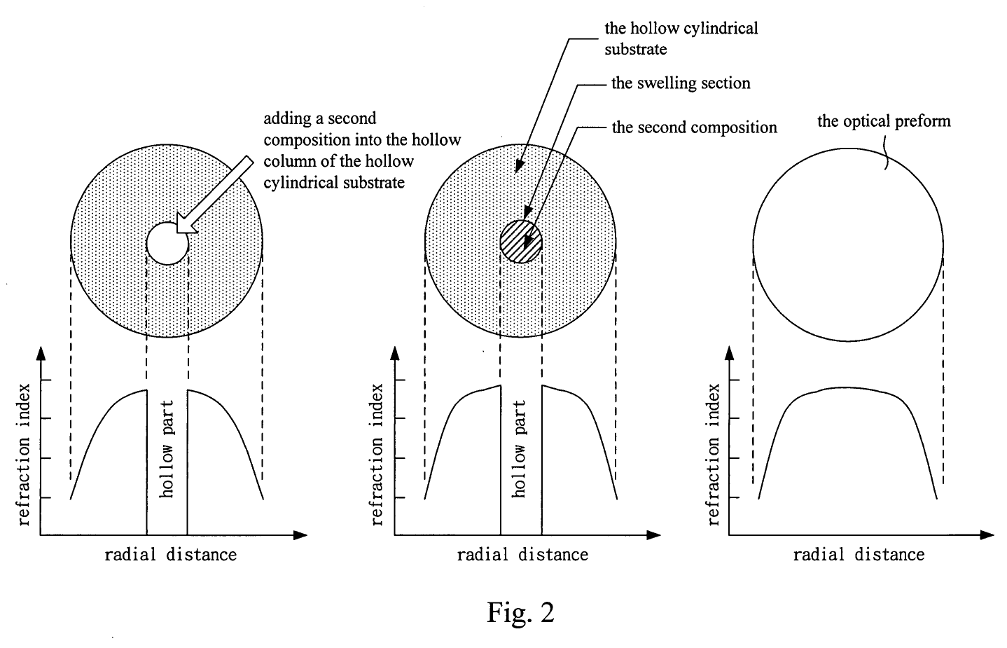

The present invention relates to a method for fabricating an optical preform for use in optical communication. The relevant steps are illustrated in FIG. 1 and FIG. 2 and described as follows. First, a first composition for the optical preform is provided. The first composition may include two or more components different from each other. In one preferred embodiment of the present invention, the first composition includes a first component having a first density and a first refraction index and a second component having a second density and a second refraction index. Preferably, the first refraction index is substantially different from the second refraction index. For example, the difference between the first refraction index and the second refraction index is greater than about 0.02, an effective refraction index gradient can be established after the centrifugal step. The first component and the second component in the first composition are preferably in a ratio (w/w) ranging from 1/1 to 9/1.

In another preferred embodiment of the present invention, at least one of the first component and the second component is previously purified. The component of higher refraction index can be pre-polymerized to be a gel-like oligomer. By doing so, the total volume shrinkage is lessened and a better refraction index profile is obtained. For example, one ingredient can be pre-polymerized at a temperature of about 60-80° C. for about 2-8 hours to obtain the desired oligomer.

At least one component for use in the method for fabricating the optical preform is required to possess an ethylenically unsaturated double bond to facilitate the necessary polymerization. The term “ethylenically unsaturated double bond” stands for any double bond active in polymerization, typical materials such as methyl methacrylate (H₂C═C(CH₃)COOCH₃, MMA, refraction index (n_{D}) is 1.49), 2,2,2-trifluoroethyl methacrylate (H₂C═C(CH₃)CO₂CH₂CF₃, TFEMA, n_{D}=1.39), 2,2,3,3-tetrafluoropropyl methacrylate (H₂C═C(CH₃)CO₂CH₂CF₂CHF₂, TFPMA, n_{D}=1.37), benzyl methacrylate (H₂C═C(CH₃)COOCH₂C₆H₅, BzMA, n_{D}=1.568), vinyl acetate (C₄H₆O₂, PVA, n_{D}=1.47) and styrene (C₈H₈, nD=1.59). An example of a material without an ethylenically unsaturated double bond is diphenyl sulfide ((C₆H₅)₂S, DS, n_{D}=1.632). If the component is fluorinated, the optical preform obtained is essentially better with respect to wavelength transmission attenuation. Other suitable ingredients may be those listed in U.S. Pat. No. 6,365,072, which is incorporated here by reference.

Next, a cylindrical reactor with a diameter is provided. The cylindrical reactor is preferably made of an inert material, which does not react with polymeric materials and can endure high temperature; for example, a metallic material such as stainless steel or aluminum. The diameter of the cylindrical reactor is preferably about 3.0-8.0 cm, and the length of the cylindrical reactor is preferably about 20-150 cm.

As shown in FIG. 1, the first composition is then introduced into the cylindrical reactor. Before the introduction of the first composition, the inner wall of the cylindrical reactor is preferably rinsed by the first composition to remove any undesirable impurities in advance. Then, the cylindrical reactor generates a suitable centrifugal field, and the temperature is subsequently raised to within a sufficient range to initiate and complete the polymerization of the first and the second components. For example, the first component may be polymerized from ambient temperature to 150° C., and the temperature is preferably increased in stepwise fashion.

The preferred centrifugal speed generated by the cylindrical reactor is represented by the following equation (1). The centrifugal speed possible ranges from 500 to 10000 rpm, according to the size of the cylindrical reactor.
r=\sqrt{2×g×h}/ω (1)

wherein r is the radius of the cylindrical reactor, g is gravity, h is the height of the cylindrical reactor and ω is the angular speed in rpm.

When the polymerization is complete, the first composition has become a hollow cylindrical substrate having an outer diameter, which is the same as the diameter of the cylindrical reactor, and an inner diameter, which is according to the quantity of the first composition added into the cylindrical reactor. The inner diameter of the hollow cylindrical substrate is usually about 0.2-3.0 cm after polymerization, the less the better. The relative refraction index profile of the obtained hollow cylindrical substrate is illustrated in FIG. 1.

In order to determine the proper refraction index of the second composition filling the hollow column defined by the inner diameter, the refraction index profile between the outer diameter and the inner diameter of the hollow cylindrical substrate is required to be measured. The measurement can be taken by a conventional preform analyzer or an interferometer.

The proper refraction index of the second composition containing two or more components is determined by the components. These components do not need to be exactly the same as those in the first composition. In one preferred embodiment, determination can be done by adjusting the ratio of the first component, having a first density and a first refraction index, to a third component, having a third density and a third refraction index, and usually results in the refraction index of the second composition being greater than the refraction index of the first composition. Empirically speaking, the refraction index of the composition is roughly the sum of the linear ratio of each component. For example, n=φ₁n₁+φ₂ n₂, wherein φ₁ and φ₂ are the molar ratios of the first and the second components, respectively, and n₁, n₂ and n are the refraction indexes of the first component, the second component, and the final copolymer, respectively.

Table 1 shows the calculated and experimental values of the refraction index of a co-polymer composed of BzMA and MMA. It indicates that the calculated values of the refraction index of the co-polymer composition are roughly the same as the experimental values. Therefore, it may be helpful in determining the ratio of the components.

TABLE 1
The calculated and experimental values of the refraction index of a
co-polymer composed of BzMA and MMA

| Components' molar ratio | | | |
|---|---|---|---|
| in composition (%) | | Refraction index of polymerized composition | |
| BzMA | MMA | calculated | experimental |
| 100 | 0 | 1.5682 | 1.5971 |
| 0 | 100 | 1.4840 | 1.4908 |
| 90 | 10 | 1.5604 | 1.5614 |
| 70 | 30 | 1.5452 | 1.5463 |
| 60 | 40 | 1.5376 | 1.5378 |
| 50 | 50 | 1.53 | 1.5320 |

Next, the formulated second composition is added into the hollow cylindrical substrate to allow swelling the hollow cylindrical substrate at a proper temperature for a sufficient period of time, preferably allowing stepwise changes in temperature. If the temperature is too low, the time period for a satisfying result is too long. If the temperature is too high, the polymerization is initiated before a satisfying swelling result is achieved, which is detrimental to the final refraction index profile. Preferably, the temperature for swelling is from about ambient temperature to a temperature that the polymerization of the second composition is initiated. A proper swelling time is determined by the components in the second composition, and the swelling time is preferably controlled to be shorter than 72 hours.

The first and the second compositions of the present invention may further contain optional additives, such as a chain transfer agent or a polymerization initiator. The polymerization initiator is preferably a radical initiator, such as 2,2′-azobis-isobutyronitrile ((CH₃)₂C(CN)N═NC(CH₃)₂CN), a.k.a. AIBN). It is known to initiate the polymerization at about 60° C. Therefore, ambient temperature to 55° C. is a suitable swelling temperature range for AIBN. AIBN is 0.05-0.5% (w/w) of the total composition, preferably 0.1-0.3% (w/w). It is recommended that AIBN be purified before use for the best results by, for example, re-crystallizing in water-bathed acetone at about 45° C.

When the hollow cylindrical substrate is ideally swelled, the temperature is then raised to within a range sufficient to initiate the polymerization of the second composition, and the desired optical preform is finally obtained. If AIBN is used as the initiator, the temperature for polymerization is preferably above 60° C. and changed in a stepwise fashion.

The method for fabricating a graded index optical preform is described by the following examples.

### EXAMPLE

1.237 g (i.e. 0.2%, w/w) of purified AIBN was added into 618 g of methyl methacrylate (MMA) and 558 g of benzyl methacrylate (BzMA) to form the first composition. Optionally, BzMA may be pre-polymerized at a temperature between 60 and 80° C. for 2-8 hours.

Then, the first composition was introduced into a pre-cleaned cylindrical reactor of 4.5 cm diameter and 80 cm height. The temperature was raised gradually under a centrifugal field of 2000-3500 rpm as listed in the table below.

| step | Temperature (° C.) | Period (hour) |
|---|---|---|
| 1 | 35 | 1 |
| 2 | 40 | 1 |
| 3 | 45 | 1 |
| 4 | 50 | 1 |
| 5 | 55 | 1 |
| 6 | 60 | 1 |
| 7 | 65 | 1 |
| 8 | 70 | 1 |
| 9 | 75 | 1 |
| 10 | 80 | 1 |
| 11 | 120 | 5 |

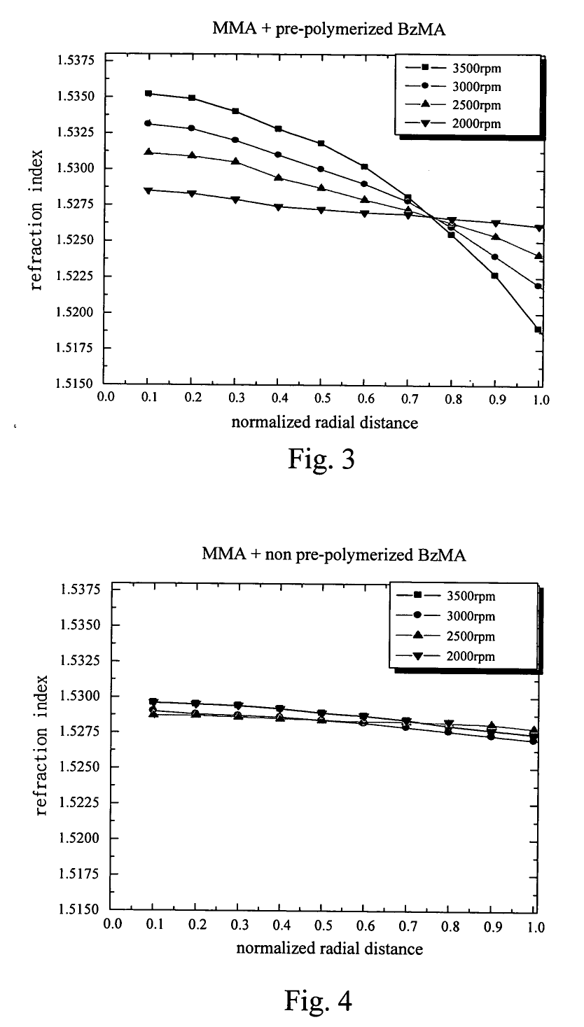

The results are displayed in FIG. 3 and FIG. 4 as “relative refraction index vs. normalized radial distance” of the hollow cylindrical substrate of an outer diameter 4.5 cm and an inner diameter 0.3 cm. Please note that the BzMA in FIG. 3 was pre-polymerized while the BzMA in FIG. 4 was not pre-polymerized.

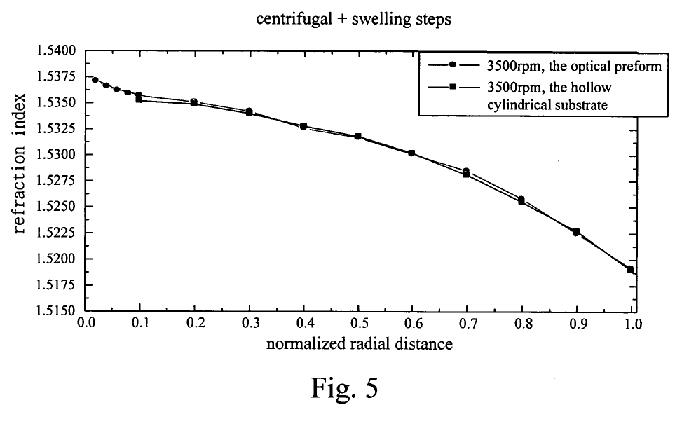

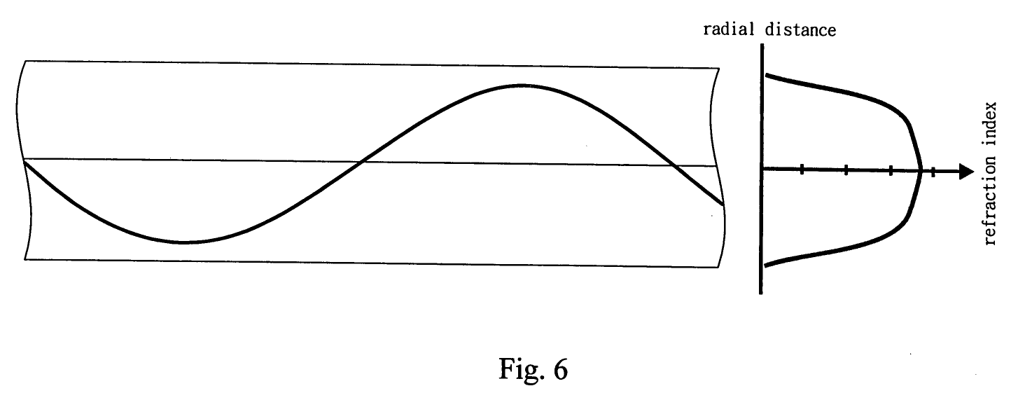

The hollow cylindrical substrate in FIG. 3 of 3500 rpm was chosen to analyze the refraction index profile; the refraction index of the second composition filling the hollow column was 1.5352. Then, 4.2 mg of purified AIBN was added into 2.15 g of methyl methacrylate (MMA) and 3.14 g of benzyl methacrylate (BzMA) (i.e. 43:57, w/w) to form the second composition. The hollow column was filled with the second composition to allow swelling. Sufficient swelling allowed the second composition to penetrate into the hollow cylindrical substrate and cause the continuity of the refraction index profile. The temperature gradient for the swelling step was 35° C. for 5 hours, 40° C. for 5 hours, 45° C. for 48 hours and 80° C. for 24 hours. Finally, polymerization was achieved at 120° C. after 5 hours. The result was an optical preform with an outer diameter of 4.5 cm. The refraction index profile is illustrated in FIG. 5. The critical refraction index was increased from 1.5350 to 1.5375, and the overall refraction index profile presented a perfect curve. FIG. 6 illustrates the light path in the obtained graded index optical preform.

Therefore, by using the method of the present invention to fabricate the graded index optical preform:

1. Repeatedly adding reactants into the reaction tank and then generating a centrifugal field is not required.

2. The graded index optical preform fabricated by the present invention does not contain a hollow column, which causes dispersion during optical signal transmission.

3. The shrinkage of the total volume is dramatically decreased, so that the voids are greatly reduced.

4. The refraction index profile of the graded index optical preform fabricated by the method of the present invention is nearly ideal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating an optical preform of graded index type, the method comprising:
adding a first composition into a cylindrical reactor with a diameter, wherein the first composition comprises a first component having a first density and a first refraction index and a second component having a second density and a second refraction index;
polymerizing the first composition in a centrifugal field to form a hollow cylindrical substrate having an outer diameter being the same as the diameter of the cylindrical reactor and an inner diameter;
measuring a refraction index profile of the hollow cylindrical substrate between the outer diameter and the inner diameter to determine a ratio of a third component, having a third density and a third refraction index, over a forth component, having a fourth density and a fourth refraction index, in a second composition, so that the refraction index of the second composition is not smaller than the refraction index of the hollow cylindrical substrate at the inner diameter;
adding the second composition into a hollow column of the hollow cylindrical substrate to allow swelling the hollow cylindrical substrate at a first temperature for a sufficient period of time; and
polymerizing the second composition at a second temperature to obtain an optical preform.

2. The method of claim 1, wherein the first component, the second component, the third component, and the fourth component are monomers, oligomers or a combination thereof.

3. The method of claim 1, wherein the diameter of the cylindrical reactor is about 3.0-8.0 cm.

4. The method of claim 1, wherein the first component has an ethylenically unsaturated double bond and is different from the second component.

5. The method of claim 1, wherein the first component, the second component, the third component and the forth component are selected from the group consisting of methyl methacrylate, 2,2,2-trifluoroethyl methacrylate, 2,2,3,3-tetrafluoropropyl methacrylate, benzyl methacrylate, vinyl acetate, diphenyl sulfide and styrene.

6. The method of claim 1, wherein a weight ratio of the first component over the second component is from 1/1 to 9/1 in the first composition.

7. The method of claim 1, wherein the difference between the first refraction index and the second refraction index is greater than about 0.02.

8. The method of claim 1, wherein the inner diameter is about 0.2-3.0 cm.

9. The method of claim 1, wherein the centrifugal field is about 500-10000 rpm.

10. The method of claim 1, wherein polymerizing the first composition in the centrifugal field is at a reaction temperature between ambient temperature and 150° C.

11. The method of claim 10, wherein the reaction temperature is raised in a stepwise fashion.

12. The method of claim 1, wherein the first composition further comprises a radical initiator.

13. The method of claim 12, wherein the radical initiator is 2,2′-azobis(2-methylpropanenitrile).

14. The method of claim 1, wherein the second composition further comprises a radical initiator.

15. The method of claim 14, wherein the radical initiator is 2,2′-azobis(2-methylpropanenitrile).

16. The method of claim 1, wherein the first temperature is from ambient temperature to a reaction temperature of initiating the polymerization of the second composition.

17. The method of claim 1, wherein the second temperature is higher than a reaction temperature of initiating the polymerization of the second composition.

18. The method of claim 1, wherein the refraction index of the polymerized second composition is greater than the refraction index of the hollow cylindrical substrate.
